(19) United States
(12) Patent Application Publication
(10) Pub. No.: US 2012/0317267 A1
(43) Pub. Date: Dec. 13, 2012

(54) PRESENCE-BASED SITE ASSIGNMENT OF A DEVICE

(75) Inventors: Allan Perry Herrod, Mission Viejo, CA (US); Larry J. Dykes, Flower Mound, TX (US)

(73) Assignee: SYMBOL TECHNOLOGIES, INC., SCHAUMBURG, IL (US)

(21) Appl. No.: 13/155,423

(22) Filed: Jun. 8, 2011

(51) Int. Cl. G06F 15/173

(52) U.S. Cl. 709/224

(57) ABSTRACT

A system and method for presence-based site assignment of a device includes a step of detecting a presence of the device by a network-managed device having a known logical location, wherein the logical location of the device is not known. A next step includes reporting the presence of the detected device to a network manager by the network-managed device. A next step includes assigning the detected device to the same logical location as the first network-managed device by the network manager. Subsequently, a next step includes a second network-managed device detecting the presence of the device and then associating to the logical location of the device. As a result the logical location of devices is inferred by the co-presence of other device having a known logical location.

### FIELD OF THE INVENTION

The present invention relates to assigning a device to a site, and in particular to presence-based site assignment of the device.

### BACKGROUND OF THE INVENTION

When managing a network, such as a wireless local area network (WLAN) for example, it is desirable to locate various devices that are or may become a part of that network. Accordingly, there are various techniques to assign a device to particular location, which can simplify asset tracking. It should be noted that it is not necessary to provide an accurate physical location of a device, which may be difficult at times, but it may only be necessary to logically locate a device anywhere within a site. A logical location or site can be defined by a customer implementing the network. For example, a logical location may be within a store or portion of a store for example. However, a logical location may or may not map directly to a physical location. Site assignment based on physical location can be challenging since it requires a reasonably accurate method to detect the physical location of a device. Further, it requires a means to reliably map a detected physical location to a corresponding logical location within the network manager, which may not be possible.

In some business applications, relay servers can be located wherever is desirable or necessary to facilitate communication between distributed managed devices and the centralized network manager. In situations where there is a one-to-one mapping between a logical location and a relay server, the network manager can use the fact that a device is communicating via that relay server to infer that the device is at the logical location served by that relay server. In such a case, the logical location has almost nothing to do with physical location, since it is determined by the communications path the device is using. In theory, if the network topology supported it, a device at one logical location could communicate via a given relay server and hence be assigned to the “wrong” logical location. That is one of the downsides of this approach since it has very little to do with physical location.

From an enterprise management standpoint, what is most important is logical location, which usually has a coarser granularity than an actual physical location. A device could be “at store 37” but be anywhere within that logical location, and it can be treated similarly to other devices at that logical location. Because logical location tends to be far less specific than physical location, one logical location could contain many physical locations. Such physical locations could be within some boundaries at a defined logical location. Alternatively, a logical location could represent many diverse (and non-contiguous) physical locations.

What is needed is an improved approach to assign a device to a logical location.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a communication network, in accordance with the present invention.

FIG. 2 is a simplified block diagram of an inference of a logical location, in accordance with the present invention.

FIG. 3 is a simplified flow diagram of a method, in accordance with one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a system and method for assigning a device to a logical location based on co-location with some other device that is known to be at that logical location, even when the physical location cannot be determined with any accuracy. In this way, the present invention allows the logical location of one device to be inferred from the logical location of another device. In particular, if a device does not have an assigned logical location, and if the device can detect the presence of another device that does have a known logical location, then that known logical location can be assigned to the device.

The present invention can be used in an enterprise where there are well-defined logical locations and there is a desire to track devices based on a dynamic determination of the logical location at which a device is being used at any given time. This idea is most useful in enterprises where there is no obvious way to determine the logical location of a device based on its relationship to the network. This invention is especially useful when none of the devices have the capability to reliably or consistently determine their physical location or where they have the capability but it cannot or will not be used (e.g. no line-of-site to GPS satellites, too much battery drain, etc.). If some devices are typically fixed (i.e. do not change locations) and other devices are typically mobile (i.e. change locations), then fixed devices can be semi-permanently assigned to their respective locations (i.e. they can be designated as “Landmarks”). Mobile devices can then determine their locations based on detection that they are co-present with fixed “Landmark” devices. In addition, if a device cannot determine its location, then this device can determine its location from another device that can determine its location.

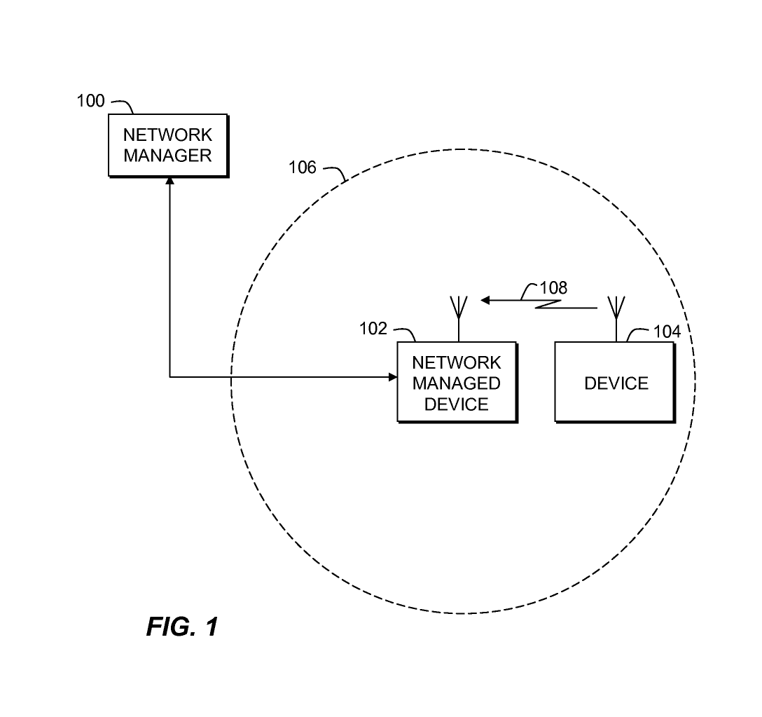

Referring to FIG. 1, there is shown a block diagram of wireless communication network (e.g. WLAN) having a network manager 100 or server, at least one network-managed device 102 (e.g. access point) and at least one other device 104 which may or may not be associated with the network. The network is adapted to support the inventive concepts of the embodiments of the present invention. Those skilled in the art will recognize that FIG. 1 does not depict all of the network equipment necessary for system to operate but only those system components and logical entities particularly relevant to the description of the embodiments herein. For example, each device shown can include a processor, memory, transceiver, interfaces, and the like, as are known in the art.

In general, components such as processors, memories, and transceivers are well-known. For example, a transceiver can be operable to communicate with user devices over an IEEE 802.11 local area wireless interface using a forward link and a reverse link. As used herein, processing units are known to comprise basic components such as, but not limited to, microprocessors, microcontrollers, memory cache, application-specific integrated circuits, digital signal processors, and/or logic circuitry. Such components are typically adapted to implement algorithms and/or protocols that have been expressed using high-level design languages or descriptions, expressed using computer instructions, and/or expressed using messaging logic flow diagrams. Thus, given an algorithm, a logic flow, a messaging/signaling flow, and/or a protocol specification, those skilled in the art are aware of the many design and development techniques available to implement a processor that performs the given logic. The devices shown can refer to a wide variety of enterprise electronic platforms such as access points, access nodes, base stations, clients, mobile stations, mobile nodes, user equipment, user stations, subscriber equipment, subscriber stations, access terminals, remote terminals, terminal equipment, mobile computers, personal computers, personal digital assistants, and the like. The devices may be wired or wirelessly coupled.

The present invention focuses on the notion of logical location instead of physical location. While it may be possible to determine the physical location of some managed devices, it also may not. But if the logical location of a managed device can be determined, it may be useful and sufficient for management purposes. The advantage of logical location is that it is less precise, and hence might be assigned by inference instead of by direct detection.

Referring back to FIG. 1, a system is shown for presence-based site assignment of a device. At least one network-managed device 102 is managed by a network manager or server 100. The network-managed device 102 has a defined and established logical location with the network manager or server 100, as can be accomplished using techniques known in the art. In accordance with the present invention, the network-managed devices 102 periodically discover (detect) all devices 104 that are co-present in their environment 106 and report their presence and their identities to the network manager 100. In this instance a device 104 can not or will not communicate its location or presence to the network manager, and may not be a network device at all. The network manager 100 can then assign the device 104 to the logical location of the network-managed device 102.

The network manager can maintain a database of all identified devices that have ever been discovered by any network-managed device and a timestamp indicating when each device has been discovered by the various network-managed devices. The database can also include a relative certainty of an inference made about a logical location of each device based on co-presence, as described herein. Although the network manager is not actively managing the devices discovered by the network-managed devices, it nonetheless maintains certain information about these devices to augment its capabilities to make inferences about devices that it does manage.

Consider a network-managed device 102 that is known to be at a given logical location at a given time and that is able to discover 108 a set of devices 104 at that time. The network manager 100 can infer that the devices discovered by that network-managed device 102 at that time are located in near proximity to the network-managed device 102. Those devices can then be assigned to the same logical location as the network-managed device 102.

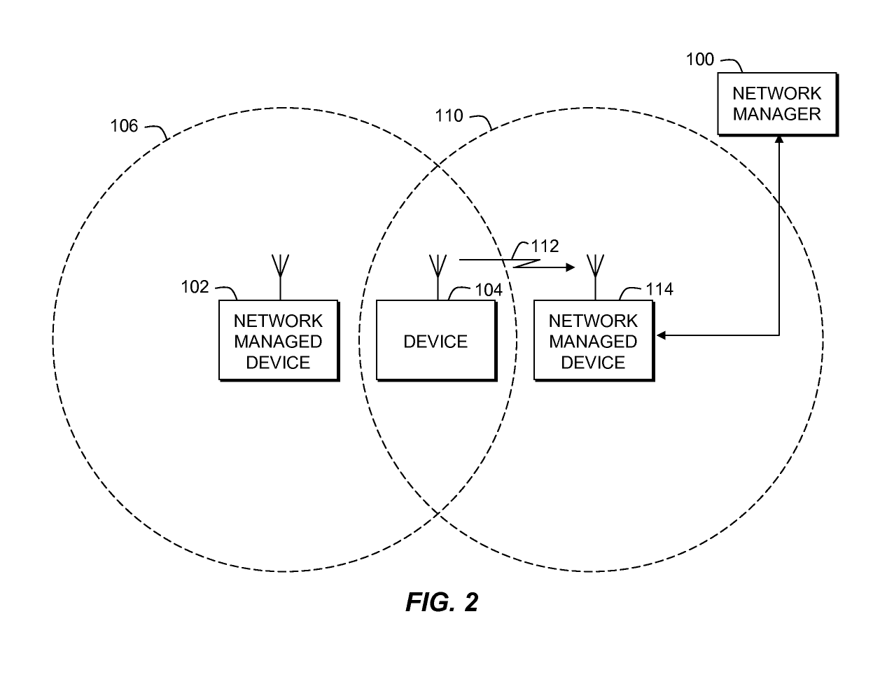

Subsequently, referring to FIG. 2, consider a second network-managed device 114 that is not assigned to any logical location at a given time and that is able to discover (detect) 112 at least one device 104 within its environment 110 at that time. If any such device 104 has been assigned to a logical location, then the network manager 100 can infer that the second network-managed device 114 is located in near proximity to that device 104. The second network-managed device 114 can thus be assigned to (or associated with) the same logical location as the device 104. Such a system could also be made more intelligent and usable in a variety of ways.

Different devices may be discovered 108, 112 using different technologies (e.g. Bluetooth peripherals, Radio Frequency Identification tags, Wi-Fi infrastructure, cellular radio telephone towers, etc.). Since the accuracy and precision of these technologies may vary, the network manager could maintain information about the relative certainty of conclusions reached based on inferences. Based on this information, the network manager can determine the conditions under which it is appropriate to assign a logical location to a device and/or to use the logical location previously assigned to a device to assign a logical location to a network-managed device or another entity.

Suppose that a network-managed device reports a given logical location and that it could discover a particular entity from that logical location. As a result, the network manager infers that the discovered entity may be at the same logical location as that network-managed device. Now suppose that another network-managed device, at nearly the same time, reports that it can also discover that same entity from a different logical location. This could allow the system to conclude that discovery of that entity is not a good indicator of logical location (has a poor relative certainty) and should not be used for that purpose, i.e. invalidate the assigned logical location of the device.

Suppose that a network-managed device reports a given logical location and that it could discover a particular entity from that logical location. As a result, the network manager can infer that entity is at that logical location. Now suppose that a variety of network-managed devices report that they can discover that same entity from a variety of logical locations, at a variety of respective different times. This could allow the network manager to conclude that entity is mobile and hence the relative certainty of the assignment of logical locations is highly time dependent. The network manager could even refine the estimation of logical location based on time as more information is obtained.

Suppose that an entity has been repeatedly discovered by a variety of network-managed devices at a variety of different times and is always inferred to be at the same logical location. The network manager might further infer that the entity is used in a fixed logical location and hence that discovery of the entity is an especially good indicator of logical location (has a high relative certainty) and that time may be of little relevance.

Suppose that a collection of entities has been discovered over time by a variety of network-managed devices, none of which were assigned to a logical location when they discovered those entities. Even though no logical location information was assigned to them, the collection of entities nonetheless forms a web of relationships that may be useful later. If a network-managed device is later assigned to a logical location, it may be able to propagate logical location information to a large number of the entities in the collection, with varying degrees of relative certainty, even if the network-managed device can only re-discover a small number of them at that time.

It can be useful to distinguish facts (e.g. this network-managed device is at this physical location and hence is known to be at this logical location) from inferred conclusions (e.g. this network-managed device can discover several entities in near time proximity to when they were discovered by another network-managed device whose location is known and hence is deemed to be at the same logical location). These conclusions may be provided to a user interface or display at the network manager. It can also be useful to indicate the relative certainty of those conclusions.

Over time, the information known about a collection of entities and about the set of network-managed devices may evolve. As this information changes, previous inferences about entities and network-managed devices might be called into question. The system could maintain a history of past inferences, what they were based on, and the relative certainty of the conclusions. As conditions change, past inferences may be re-evaluated and past conclusions can be modified to fit the new facts, and/or the relative certainty of past conclusions can be adjusted to fit the new circumstances.

Optionally, the present invention can provide automatic reconfiguration of devices for use that varies based on their determined logical location. For example, the configuration of a device could be altered to suit the environment at a location and/or different software could be loaded to perform the types of applications required at a location. Of course, if a device is not connected to the network at all, then it cannot be reconfigured by a management system while it has no connectivity. But if/when the device does have connectivity then it could be so configured. And the fact that a device has connectivity does not mean that its logical location can necessarily be determined from the network via which it is communicating. Many networks have no way to determine the location of a source node within the network. But if a device has connectivity with the management system and the management system can infer the logical location of the device, then the management system could automatically apply configuration to that device that is appropriate for the logical location where it is being used.

In many cases, physical locations where devices can be used can be mapped to logical locations within the network. If a given device is used at a single fixed physical location, then it can be appropriate to statically assign the device to a corresponding fixed logical location. If a device can “roam” amongst various physical locations, then it can be desirable to automatically assign the device to a logical location corresponding to its determined physical location. In this way, the device could be tracked based on a dynamic determination of the logical location at which the device is being used.

The present invention does not necessarily solve the problem of determining the logical locations of every device, nor is it intended to. But if a mechanism exists to determine the logical location of some devices, the present invention permits the propagation of logical locations by inference based on the direct or indirect detection of co-presence of those devices. This leads to a number of interesting scenarios.

For example, within a building, line-of-site visibility to GPS satellites, which is required for the determination of physical location, might be severely limited. If a single network-managed device within the population of devices operating within the building can determine its physical location (e.g. that device is by a window and does have line-of-site to GPS satellites), then the logical location of that network-managed device may be successfully determined. Then, the logical location of other co-present devices can be inferred, even though the physical locations of those device may not be known (e.g. since they do not have line-of-site to GPS satellites).

For a population of managed mobile devices, battery life is often a key concern. The operation of a physical positioning system can place a significant load on the battery of a device. If all devices are frequently acquiring and reporting their physical locations, battery life can suffer. Instead, a set of co-present managed devices can be configured such that some of the devices acquire and report their physical locations, based on a defined schedule. At any given time, the logical location of all devices whose physical location is known can be determined based on the physical location most recently reported and the logical location of all devices whose physical location is not known can be inferred based on co-presence. This can significantly reduce overall power consumption because communications mechanisms used to detect co-presence often use much less power than mechanisms used to detect physical location and because the burden of periodically detecting physical location can be distributed among a plurality of devices.

Within a population of managed devices, device capabilities may vary. Devices used by some users (e.g. factory workers) may lack a physical positioning system while devices used by other users (e.g. supervisors) might include a physical positioning system to accommodate their mobile usage profiles. By inferring the logical location of co-present devices from the known logical location of other devices, overall solution cost could be reduced without losing the ability to track the location of all devices.

In some situations, it may not be possible to directly determine the logical location of any network-managed devices. In such a case, it may be necessary to manually assign devices to logical locations (e.g. from a management console). Manually assigning a logical location to every device individually and keeping those assignments up to date may be quite difficult. If a logical location is assigned to a single device, that logical location could be inferred for all co-present devices. This can be especially useful when some devices are fixed and others are mobile since locations can be assigned to fixed devices and inferred for mobile devices.

Some devices may have an available means to determine their physical location but there may be a charge for that service. For example, a cellular-equipped device may have the ability to report which cell tower(s) it can detect. The cellular carrier may offer the ability to locate a device based on cell tower triangulation, for a fee. If precise physical location is not required, the cell tower(s) that device can detect might be adequate to infer co-presence without the need for a paid service.

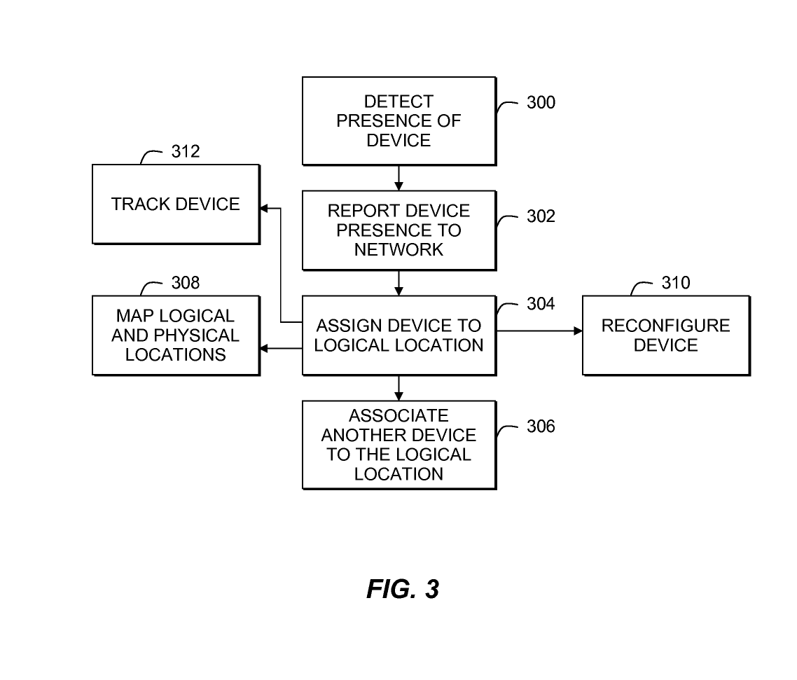

FIG. 3 shows a method for presence-based site assignment of a device, in accordance with the present invention.

Step 300 includes detecting the presence of a device by a network-managed device, wherein the logical location of the detected device is not known, but the logical location of the network-managed device is known. In this instance the device can not or will not communicate its location or presence to the network manager.

Step 302 includes reporting the presence of the detected device to a network manager by the network-managed device.

Step 304 includes assigning the detected device to the same logical location as the network-managed device by the network manager. This step can include maintaining a database of detected devices along with timestamps of the times of detection by at least one network-managed device and relative certainties of inferences made about logical location based on co-presence, as described herein.

Step 306 includes a second network-managed device detecting the presence of the device, wherein the logical location of the detected device is known, but the logical location of the second network-managed device is not known, reporting the presence of the detected device to a network manager by the second network-managed device; and assigning the same logical location as the detected device to the second network-managed device by the network manager. This step can include propagating logical locations based on subsequent detection of the presence of a device having a known logical location by other devices that do not have an assigned logical location.

Step 308 includes mapping between a physical location and the logical location where the device is being used, where the network-managed device is in a fixed physical location.

Step 310 includes reconfiguring the device for a use according to the logical location.

Step 312 includes tracking the device based on a dynamic determination of the logical location at which the device is being used

Advantageously, the present invention allows the inference of the logical location of a device by detecting the presence of another device with a known or inferred logical location. This can be done even when the physical locations of either device cannot be determined with any accuracy. In addition, the logical locations of devices can be propagated by detecting the presence of other devices having an assigned logical location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors or devices such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs for ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for presence-based site assignment of a device, comprising:
detecting the presence of a device by a first network-managed device, wherein the logical location of the detected device is not known, but the logical location of the first network-managed device is known;
reporting the presence of the detected device to a network manager by the first network-managed device; and
assigning the detected device to the same logical location as the first network-managed device by the network manager.

2. The method of claim 1, further comprising:
detecting the presence of the device by a second network-managed device, wherein the logical location of the detected device is known, but the logical location of the second network-managed device is not known;
reporting the presence of the detected device to a network manager by the second network-managed device; and
assigning the same logical location as the detected device to the second network-managed device by the network manager.

3. The method of claim 2, wherein assigning includes propagating logical locations based on subsequent detection of the presence of a device having a known logical location by other devices that do not have an assigned logical location.

4. The method of claim 1, wherein the network-managed device is in a fixed physical location, and further comprising mapping between a physical location and the logical location where the device is being used.

5. The method of claim 1, further comprising reconfiguring the device for a use according to the logical location.

6. The method of claim 1, further comprising tracking the device based on a dynamic determination of the logical location at which the device is being used.

7. The method of claim 1, wherein assigning includes maintaining a database of detected devices along with timestamps of the times of detection by at least one network-managed device and relative certainties of inferences made about logical location based on co-presence.

8. A system for presence-based site assignment of a device, comprising:
a network manager; and
a first network-managed device having a known logical location and managed by the network manager, the first network-managed device operable to detect the presence of a device, wherein the logical location of the device is not known,
wherein the first network-managed device is operable to report the presence of the detected device to the network manager, and wherein the network manager is operable to assign the detected device to the same logical location as the first network-managed device.

9. The system of claim 8, further comprising a second network-managed device where the logical location of the second network-managed device is not known, wherein the second network-managed device is operable to detect the presence of the detected device, and wherein the network manager is operable to assign the same logical location as the detected device to the second network-managed device.

10. The system of claim 8, wherein subsequent detections of the presence of a device having a known logical location by other devices that do not have an assigned logical location propagates the logical location.

11. The system of claim 8, wherein the network-managed device is in a fixed physical location, and wherein the network manager is operable to map between a physical location and the logical location where the device is being used.

12. The system of claim 8, wherein the network manager is operable to reconfigure the device for a use according to the logical location.

13. The system of claim 8, wherein the network manager is operable to track the device based on a dynamic determination of the logical location at which the device is being used.

14. The system of claim 8, wherein the network manager is operable to maintain a database of detected devices along with timestamps of the times of detection by at least one network-managed device and relative certainties of inferences made about logical location based on co-presence.

15. The system of claim 9, wherein if the first network-managed device and the second network-managed device detect the same device but at different logical locations the network manager is operable to invalidate the assigned logical location of the detected device.

16. The system of claim 9, wherein if the first network-managed device and the second network-managed device detect the same device but at different logical locations at different respective times, the network manager is operable to estimate a logical location of the detected device based on time.

17. The system of claim 9, wherein if the first network-managed device and the second network-managed device detect the same device at the same logical locations at different times, the network manager is operable to assign a fixed logical location of the detected device.

18. The system of claim 8, wherein if the detected device is able to determine its physical location, then the network manager can infer the logical location of any other device co-present with the detected device.

19. A wireless local area network for presence-based site assignment of a device, comprising:
a wireless local area network server; and
a network-managed device having a known logical location and managed by the server, the network-managed device operable to detect a presence of the device, wherein the logical location of the device is not known and the device does not report its presence or location to the server,
wherein the network-managed device is operable to report the presence of the detected device to the server, and wherein the server is operable to assign the detected device to the same logical location as the network-managed device.
